(19) United States
(12) Patent Application Publication
(10) Pub. No.: US 2004/0015843 A1
(43) Pub. Date: Jan. 22, 2004

(54) Method and program product for structured comment assists in computer programming

(75) Inventor: Dennis A. Quan JR., Quincy, MA (US)

Correspondence Address: Floyd A. Gonzalez - Attorney, IBM Corporation, MS P386, 2455 South Road, Poughkeepsie, NY, 12601, US

(73) Assignee: International Business Machines Corporation, Armonk, NY (US)

(21) Appl. No.: 09/855,877

(22) Filed: May 15, 2001

(51) Int. Cl. G06F 9/44

(52) U.S. Cl. 717/110; 717/113; 717/114

(57) ABSTRACT

A method for creating and using program comment fields in a program listing to augment the functionality of a program language architecture. Standard comment fields are uniquely identified to contain special augmenting commands. These commands are used by program editors to augment the program functions. A help notification mechanism is provided to automatically provide appropriate comment field hints to the programmer.

### FIELD OF THE INVENTION

This invention relates to the field of computer programming tools and in particular to an intelligent real time tool to assist a programmer during the writing, evaluation, and/or maintenance of a computer program.

### BACKGROUND OF THE INVENTION

Two related problems exist in the field of computer programming that include, but are not limited to, generating a computer program quickly and accurately on a first attempt, and maintaining a computer program with a minimal amount of effort once a computer program exists. Program listings are created and maintained by executers which are themselves programs. These executers (including, but not limited to, program editors, interpretive source code execution applications, source code compilers and simulators for example) are programs that operate on program listings (usually by interpreting the program statements in the program listing) and normally provide a Graphical User Interface (GUI) to a human programmer. Other kinds of executers exist including programs that interpretively execute the statements in a program listing, The two related problems exist due to many factors that include, but are not limited to, the increasing complexity of computer programs generally, the architectural modularity of computer programs, and the increasing distribution of programmers that are contributing to a common program across campuses, countries, and even continents. Each of these factors places a premium on the efficiency of a programmer whose role is to develop and/or maintain a computer program. Various methods are known in the art to address the problem. For example, U.S. Pat. No. 6,026,233 “Method and apparatus for presenting and selecting options to modify a programming language statement” (Schulman et al.), which is incorporated herein by reference provides a method for a program editor to assist a programmer so he doesn't have to rely on extraordinary means to correctly code a program.

The referenced Schulman patent generates automatically and/or manually invoked assist windows that contain information applicable to a programming language statement that is proximate to the present location of the character position cursor. The assist window information can be used to complete at least one portion of a programming language statement being constructed by the programmer. The assist information can also be used by the programmer to obtain help that is relevant to the immediate portion of the programming statement by supplying information relevant to the present location of the character position cursor in the immediate programming language statement.

The prior art doesn't provide for the case where a first version of a program architecture doesn't provide a function that could enhance the functionality of the language. When the shortcoming is discovered, it may be overcome by adding architected function to the program architecture in a later release of the program. The problem exists that in this case, the needed function isn't provided in the earlier released environment and is only provided in unique code statement enhancements to the program for the newer environment, thus the new function code is not useable in both the new environment and the old environment.

An example of the problem is found in an early version of ECMAScript which is a “type”-less language. A programmer using ECMAScript must separately keep track of statement variable type. A later version of the code provided type-ing statements but the use of these rendered the code unusable in environments that used the old level of executer. A method is needed in ECMAScript to provide type-ing in a way that it doesn't interfere with execution in an old level of executer and still provides type-ing in the new levels of executers.

Object Oriented “type” manipulation is described in U.S. Pat. No. 6,202,202 (Steensgaard) “Pointer analysis by type inference for programs with structured memory objects and potentially inconsistent memory object accesses” assigned to Microsoft Corp. U.S. Pat. No. 6,202,202 is hereby incorporated by reference. The Steensgaard patent discloses a pointer analysis by type inference for a computer program with structured memory objects and potentially inconsistent memory object accesses helps approximate run-time store usage for the program. The analysis represents locations for the program with types describing access patterns for the represented locations based on how the locations are accessed in the program. The analysis describes access patterns for structured memory objects, elements of structured memory objects, and memory objects accessed in inconsistent manners in the program. The analysis identifies store usages described by the program and determines whether the location(s) and/or function(s) affected by the identified store usages are well-typed under typing constraints. If the identified store usages are not well-typed, the analysis modifies types for location(s) and/or function(s) affected by the identified store usages as necessary so the store usages are well-typed. When the locations and/or functions for all identified store usages are well-typed, the program is well-typed with the set of types defining a store model for the program.

Exemplary Computing Environment—(FIG. 1)

FIG. 1 illustrates a block diagram example of a general purpose computer system 100 that is suitable for use with the executer. However, the executer is operable in any of the several computing environments that can include a variety of hardware, operating systems, and program modules that are all commercially available in the industry. Program modules include, but are not limited to, routines, programs, components, data structures, and the like that perform particular tasks and/or implement particular abstract data types. Moreover, persons skilled in the art appreciate that the executer can be practiced with other computer system configurations including, but not limited to, hand-held devices, network computers, multiprocessor based systems, microprocessor-based or other general purpose or proprietary programmable consumer electronics, minicomputers, mainframes, and the like. The executer may also be practiced in distributed computing environments where tasks are performed by remote processing devices that are linked through communications networks. In a distributed computing environment, program modules may be located in and/or executed from local and/or remote memory storage devices.

The executer and any other necessary programmed instructions and/or commands are executable on processor 102. Processor 102 stores and/or retrieves programmed instructions and/or data from memory devices that can include, but are not limited to, Random Access Memory (RAM) 110 and Read Only Memory (ROM) 108 by way of memory bus 152. Another accessible memory device includes non-volatile memory device 112 by way of local bus 150. User input to computer system 100 is entered by way of keyboard 104 and/or pointing device 106. Human readable output from computer system 100 can be viewed on display 114 or in printed form on local printer 115. Alternatively, computer system 100 is accessible by remote users for purposes that can include debugging, input, output and/or generating human readable displays in printed and/or display screen output form, or any other output form, by way of a Local Area Network (LAN) or Wide Area Network (WAN) 116.

Certain attributes of a program language may resist the previous information tools since the program language may not incorporate the assist functions required. Program Editors for some languages such as C++, Visual Basic, and Java take advantage of variable type declarations to determine the “types” of variables defined by the programmer. Examples are:

Dim X as Form (Visual Basic) defines “X” as having the type “Form”

Ostream* os; (C++) defines “os” as having the type “Ostream”

Java.io.Reader reader; (Java) defines “reader” as having the type “Java.io.Reader”

By knowing the types of variables, the editor can determine the correct choices to be presented in the assist window. However, in languages without variable type declarations (such as ECMAScript), it is impossible for the editor executer to determine the types of programmer defined variables. Unlike statically-typed languages, where types can be inferred from code statically, ECMAScript uses dynamic typing (i.e. Runtime type determination), which makes it computationally not feasible to determine these types during editing.

Often it is the case, however, that ECMAScript is used in conjunction with certain objects made available by the “host” of the ECMAScript interpreter whose types are fixed. An example is the use of ECMAScript in a web browser. Objects such as window and document are exposed to ECMAScript within an HTML document from the host of the ECMAScript executer, namely, the web browser. These objects have fixed type as defined by the W3C HTML DOM standard.

Java language uses special comments to provide a way to generate source code documentation (Javadoc). As exemplified by the following:

/**This is a javadoc comment @author Dennis Quan */

Java uses a double asterisk at the beginning of a comment field to identify a special comment that will be used by Javadoc to generate documentation from a source code listing. This allows a tool (separate from the Java compiler) called javadoc to parse the source files and automatically generate source code documentation, a useful thing to do since programmers aren't likely to document their code in separate documents. Notice the use of the @author keyword to designate which part of the comment includes author information. This is a use of comments for creating human-readable documentation. It doesn't provide any functionality to the program listing.

Special comments are used by Microsoft Java/Windows/ActiveX integration to extend their version of the Java language to support ActiveX (ActiveX is Microsoft's proprietary component technology). Since the Java compiler is already aware of (but does little with) Javadoc comments, they have used this as a convenient basis for their proprietary language extensions. In this sense the /** . . . */ comments are similar to preprocessor instructions in C or C++ (e.g., #include, #define, etc.) In that they are directives meant to be processed before the compiler sees the code.

An example of the ActiveX format is:

/** @dll.import(“KERNEL32”)*/

public static native int GetEnvironmentStrings( );

These special commands, instead of being used for documenting a function, are used to declare to the compiler some attribute of the function (for example, that the function GetEnvironmentStrings is implemented in a library named KERNEL32). These comments are mandatory. They provide functionality for the context of the program. The function within these special commands must be interpreted for the program to function correctly. As such they could be considered an addition to the syntax of the language. Here are the key differences.

ActiveX special commands fail to provide means to specify type declarations. Instead, ActiveX provides a means for specifying where the function is implemented (in a native Windows-specific library usually). In ActiveX, an incorrect special command specification could cause compiler errors or cause the program not to execute correctly; hence, it is modifying the semantics of the language. ActiveX doesn't provide means for backward compatibility in that the special commands are required for proper execution of the code, they haven't addressed the need to provide code extensions that permit new functions to be performed in new execution environments while keeping functionality in old execution environments. Therefore, ActiveX function could have been equally performed using architectural modifications (new Java syntax).

Microsoft recognized the deficiency of ECMAScript language (in that it didn't provide type declaration capability). They solved this in JScript.NET (their new implementation of ECMAScript) by introducing new syntax in order to solve the problem. Their new syntax however does not work with earlier versions of ECMAScript executers and is nonstandard.

An editor is thus able to give syntax assistance in the specific circumstances where one of these predefined host objects is used since the host object has a predefined type. It is not, however, able to give assistance when programmer defined variables are used, even when it is completely obvious. For example:

var x=window;

By declaring x to refer to the window object, it is evident that x now has the same type as window. However, the editor cannot make this deduction in general because of the dynamic typing of ECMAScript. In addition, there is no way in this language (as in other scripting languages) to inform the editor of the type, as can be done in Visual Basic using the Dim keyword for example.

For example, in a program language, “Standard” ECMAScript program language had no facility for specifying a variable type to a variable:

var x=expression_a;

In the above example, expression_a represents a value that has no predefined type. A more recent release incorporates a method for a programmer to assign a variable type, thus:

var x: Window=window;

This solution is incompatible with the previous level of ECMAScript where such an expression would not be supported for assigning type. A method is needed that would allow programmers to interact with existing program structures with enhanced tools.

### SUMMARY OF THE INVENTION

The foregoing problems and shortcomings of the prior art are addressed and overcome and further advantageous features are provided by the present invention.

In certain environments, program code (listing) instructions are deficient. An example is in object oriented programming when parameters in the object to be coded are defined by other program objects. In this case, the programmer must make sure that his code is consistent with other modules. Another example is that it is desirable to be able to use new versions of executers (editors, simulators and program interpretive execution applications for example) on old versions of program listings, while taking advantage of functionality of a newer version. Another example is that it is desirable to add functionality to a program listing for special environments without disturbing the basic function of the program. In these cases, if the program were modified to perform the functions, it would no longer be compatible with it's intended environment.

The present invention utilizes special program listing statements that are ordinarily ignored by executers (compilers, simulators and interpretive program execution environments for example). In most program languages, the comment field can be used to provide the special program listing statement, but the invention is not restricted to the use of comment field. The invention could also be practiced by incorporating a table space that is not referenced directly by the program. The table space would relate special comment function to the appropriate location in the program listing. Furthermore, the table space could be implemented in a file separate from the program listing altogether. The comment field embodiment is used to provide an example of how one would implement the present invention.

Accordingly, the comment field of a programming architecture is transformed into an operational statement (or statements) by the present invention.

While the present invention could be practiced by transforming all comments in a program listing to executable statements, in the preferred embodiment, it is advantageous to provide conventional comments in combination with the executable comments (herein referred to as “special comments”). Thus, the present invention further defines a subset of the comments as executable. This is preferably accomplished by structuring the special comment in a way that uniquely differentiates it with conventional, non-executable comments. In a preferred embodiment the special comment field contains predefined special characters in a predefined location within the conventional comment format. Thus, in this embodiment, an ordinary comment contains special characters to identify it as a special comment and further contains information preferably such as instructions, data, instruction modifiers and the like according to the needs of a programming environment.

The present invention permits a programmer to embed special comments of a specific form into a programming language. The special comments are then recognized, by a compiler for instance, to provide special functionality that is not ordinarily supported by the program language.

An example that is shown for explanation is as follows:

In the current release of ECMAScript, static type declaration is not supported. The invention provides for a special comment field to imbed type declarations in the code listing in comment fields. Tools are then provided to support the special comment type assignment in Type Managers, Expression Parsers, Comment Parsers, and Comment Auto-inserters as if they were part of the native program language. The special comments incorporate a special format to differentiate them form ordinary comments. For example, in many languages a comment is defined by /* followed by commenting text ended by */. Thus the expression:

/*xxxxxxxxxxxxxxxxxxxxxxxxxxxxxxxxx*/

Is a comment incorporating a string of x's. In the present invention, a predefined convention is used that reserves certain comments as the special comments. An example might be a comment field beginning with “$$”. Thus;

/*$$xxxxxxxxxxxxxxxxxxxxxxxxxxxxxxx*/

Becomes a special comment.

Special comments of this invention can generally be thought of as extensions to program listing executables. These special comments are detected and executed by special compilers that are designed to execute special comment function that is not incorporated in the native programing architecture. Such special compilers may be used in program editors or source code executers for example.

It is therefore, an object of the present invention to provide special function to a programming language comment field using a unique comment field.

It is another object of the present invention to provide special function facility to assist a program editor.

It is another object of the present invention to provide interpretivly operational content to a programming language comment field.

It is a further object of the present invention to use special function comments to define type to a variable.

It is yet another object of the present invention to provide a method to assist a programmer in creating special function comments.

It is still another object of the present invention to provide a method to automatically apply special programming language comments to a program listing.

### BRIEF DESCRIPTION OF THE DRAWINGS

The subject matter which is regarded as constituting the invention is particularly pointed out and distinctly claimed in the claims at the conclusion of the specification. The foregoing and other objects, features and advantages of the invention are apparent from the following detailed description taken in conjunction with the accompanying drawings in which:

FIG. 1 illustrates a block diagram of an exemplary computing environment in which the present invention can be implemented;

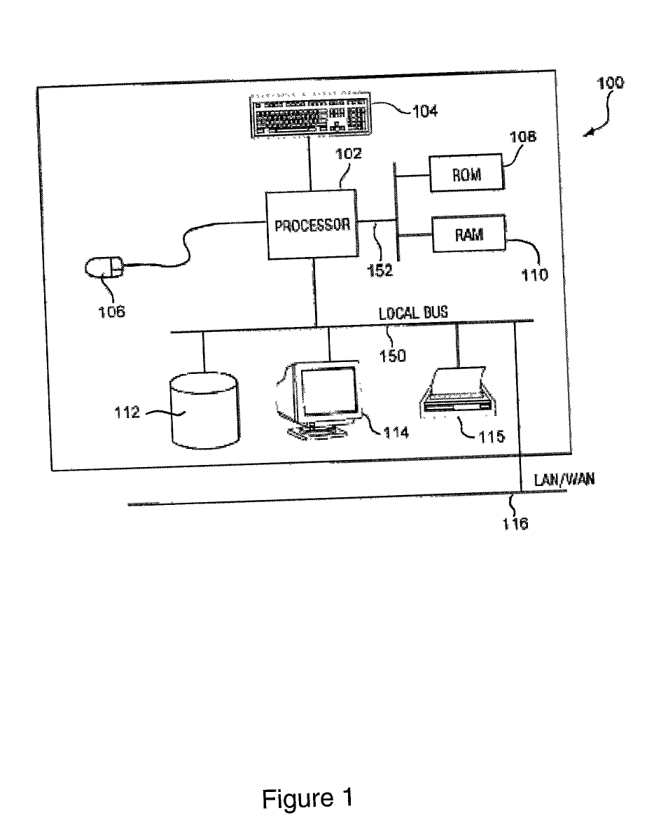

FIG. 2 is a flow chart that demonstrates components of a preferred program editor;

FIG. 3 is a flow chart that demonstrates components of the present invention in a preferred program editor;

FIG. 4 is a flow chart that demonstrates an embodiment of the present invention in an interpretive execution or simulation environment;

FIG. 5 is a flow chart that demonstrates an embodiment of the present invention using two versions of an executer;

FIG. 6 demonstrates a prompt assistance sub-window according to the invention;

FIGS. 7, and 8 demonstrates providing a special comment to a program listing;

FIG. 9 is a flow chart demonstrating creating a special comment in an editor; and

FIG. 10 is a flow chart demonstrating prompt assistance for creating special commands.

### DETAILED DESCRIPTION OF THE PREFERRED EMBODIMENT

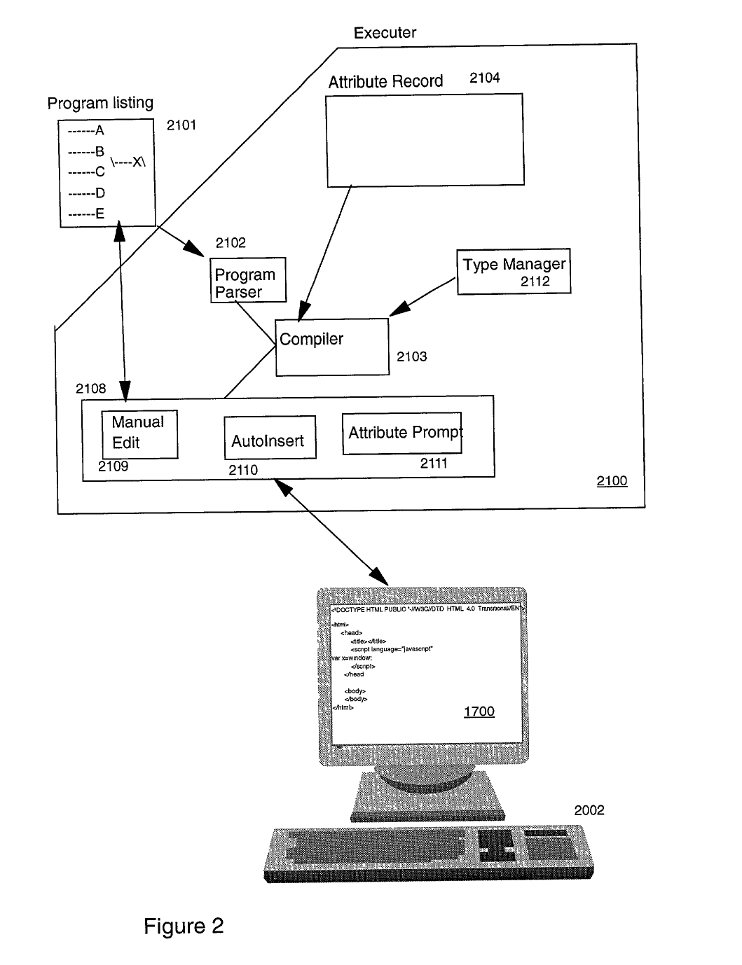

Referring to FIG. 2 a preferred embodiment of the present invention is depicted in a program editor environment. A conventional program listing 2101 includes program instruction statements A, B, C, D and E. The listing also includes program comment statement X. The program listing is displayed on terminal 2002 as display 1700. Operations 2108 are performed on the program listing by the editor executer 2100. These operations include, but are not limited to Manual Edit 2109, permits the programmer to directly enter statements that are incorporated in the program listing 2101; AutoInsert 2110, incorporates statements in the program listing 2101 automatically according to a predetermined functionality of the editor; and, Attribute Prompt 2111, provides display prompts (ordinarily sub-windows) to assist the programmer in performing manual editing 2109.

The editor conventionally parses 2102 the program listing statements 2101 and provides the parsed program to a compiler 2103 that interacts with the editing function 2108 to assist the programmer in editing his program. The compiler uses an attribute record 2104 to keep track of the current state of the statements in the program and a type manager 2112 to provide type information to the compiler.

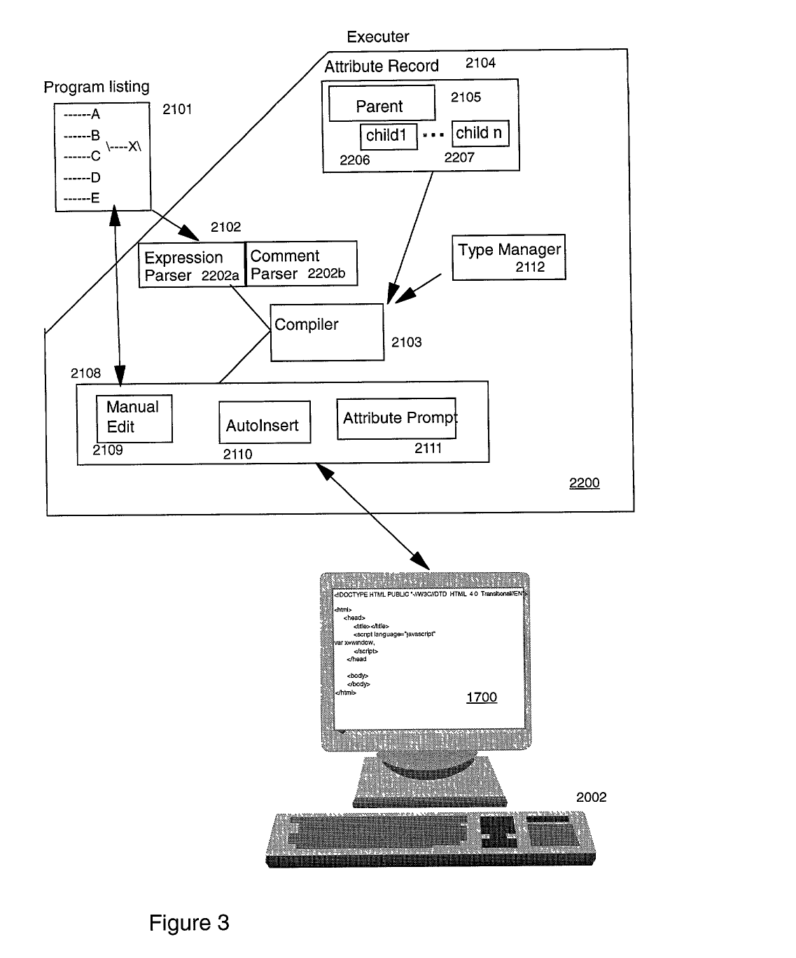

In FIG. 3, an embodiment of the present invention, the program listing 2102 parser in the executer 2200 includes a comment parser 2201b as well as a conventional parser 2201a. The comment parser ignores conventional comments and sends statements found in special comments to the compiler 2103 and the editor components 2108. In this embodiment, the attribute record 2104 keeps records of attributes according to the program block that they are related to. Parent attribute record 2105 contains global attributes and child1 attribute record 2106 contains attributes associated with a block of the program delineated by brackets “{” and “}” and position in the program sequence.

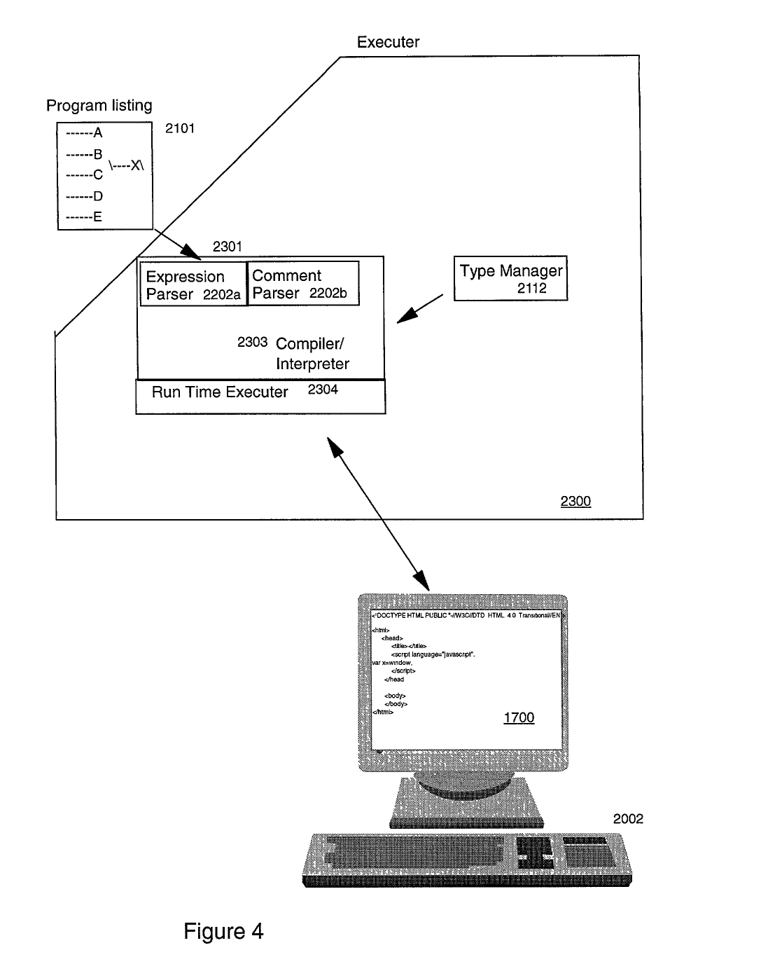

FIG. 4 depicts an embodiment of the present invention as it would be implemented to assist a run-time execution 3204 executer 2300 of a program listing 2101. Here, the compiler/interpreter 2303 receives parsed instructions 2202a and parsed special comments 2202b which are interpretively executed by the interpretive run time executer 2304.

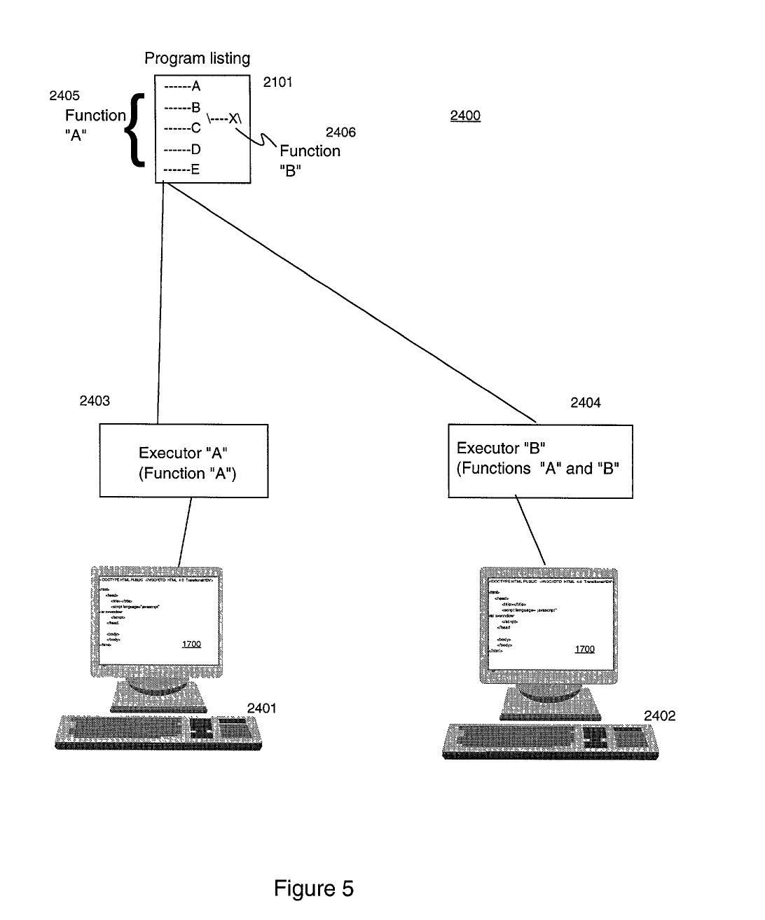

FIG. 5 depicts an embodiment of the present invention wherein an example program (program listing) 2101 includes both a basic function “A” 2405 and an optional function “B” 2406. Executer “A” 2403 is an early version of an executer and doesn't support the optional functions incorporated in the comment fields. Therefore Executer “A” 2403 interprets the architected statements 2405 in the program listing 2101 and ignores all comment fields 2406, thereby performing basic function “A” 2405 only. Executer “B” 2404 represents a newer version of the executer which is able to interpret predefined special comments 2406 to perform an optional function “B” 2406. Therefore Executer “B” 2404 performs not only the basic function 2405 (as does executer “A” 2403) but also the optional function “B” 2406. The same example program 2101 runs correctly on both executers but Executer “B” 2404 is able to perform additional function 2406 because of the special comment fields 2406 of the present invention.

Special Comment:

A “Special Comment” is defined that will preferably, consistently differentiate special comments from ordinary comments in a program listing.

Special comments can be incorporated in program listings by using techniques other than using program listing comments and be consistent with the teaching of the present invention. An example means to avoid special commenting would be to create a separate listing for the special comments that are with the program listing for editing purposes only. This separate listing optionally cooperates with the program listing and includes special comment function as well as locating means to direct the special comment function to the appropriate program listing function.

Preferably, special comments will utilize program architecture dependent commenting techniques. An example convention would be to start the comment with “$$” leftmost oriented in the comment field. It should be obvious that other mechanisms could be used to identify the special comment including, but not limited to the use of different special characters that are not ordinarily used in comment field such as “˜˜”; “###”; “ [symbol] ˜ [symbol] ”. The options are virtually limitless. Different position, length, number of and content of the characters used to identify the special comment can be chosen than are described herein but would be consistent with the teaching of the present invention. In order to teach the invention, special comments are indicated hereafter by leading and trailing explanation marks “!” Within the conventional comment delimiters. Thus special comments take the format of:

/*!xxxxxxxxxxxxxxxx!*/

In one embodiment, the special comment function is provided entirely by the special comment:

/*!x:type!*/

var x=expression_b;

In another embodiment, the special comment function is provided by positioning the special comment next to a code statement as:

var x=expression_b /*!type!*/

Where x is implicitly the expression that is assigned “type”.

In another embodiment, the special comment specifies another expression as the type defining expression, thus var x is a type specified in “expression_b” as follows:

var x=expression_c /*!expression_b!*/

The special comment could provide a level of indirection to the type and be encoded in the comment in a form unrecognizable to the programmer. These and other techniques known in the art are consistent with the teaching of the present invention as long as the comment field participates in the assignment.

Expression Parser:

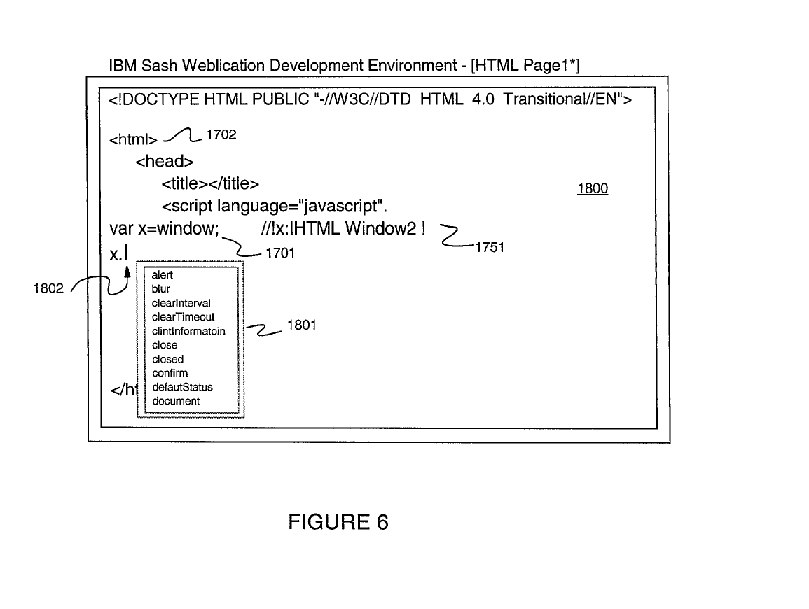

In FIG. 6, the expression parser is capable of examining the tokens preceding the cursor 1802 to determine the type of the object (if any) being specified at the cursor 1802. This is generally done in a language-specific fashion. The expression parser uses information provided by the type manager for making type deductions. FIG. 6 shows the effect of the expression parser parsing an expression 1701 using the type defining special comment 1705 to provide the hint window 1801.

Comment Parser:

The Comment Parser is capable of recognizing specific comment formats (such as /*!variablename:type!*/) and keeping a record of the types assigned to variable names. The Comment Parser detects the special comment format (/*! !*/) and parses the expression within the special comment (variablename:type). This information is used by the expression parser, for example, when deducing the types of expressions involving programmer defined variable names. Additionally, the comment parser can be sensitive to block scoping. That is, comments declaring types of variables that are local to specific blocks of code may only have validity when editing code within those respective blocks. Blocks of code may be identified by beginning and ending special characters such as { }, [ ] or any means known in the art.

Comment Auto-Inserter:

When the programmer enters assignment statements, i.e., statements that declare and initialize a variable, the editor can use the expression parser to statically determine the type (if any) of the expression being assigned to the variable and generate a special comment to inform the editor in the future of the type assigned to that variable.

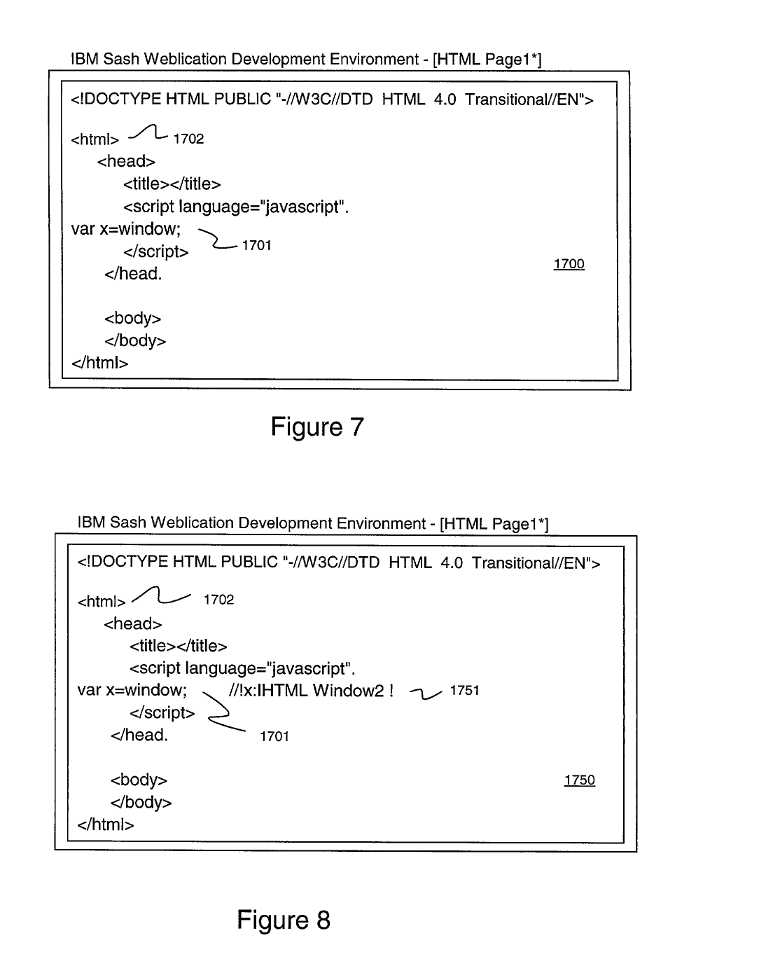

FIG. 7 is an example computer screen 1700 depicting a program listing beginning at 1702 where a type has not been defined for var x 1701. FIG. 8 shows the results of autoinsertion of the special comment defining the var x type as “IHTMLWindoww2” by inserting a type defining special comment 1751 of:

/!x:IHTMLWindow2!/

Type manager:

The type manager is responsible for holding information about the types of objects supplied by the host. Type information includes a specification of the methods, properties, constants, and events associated with a type, as commonly defined by the object oriented programming paradigm.

AutoInsertion:

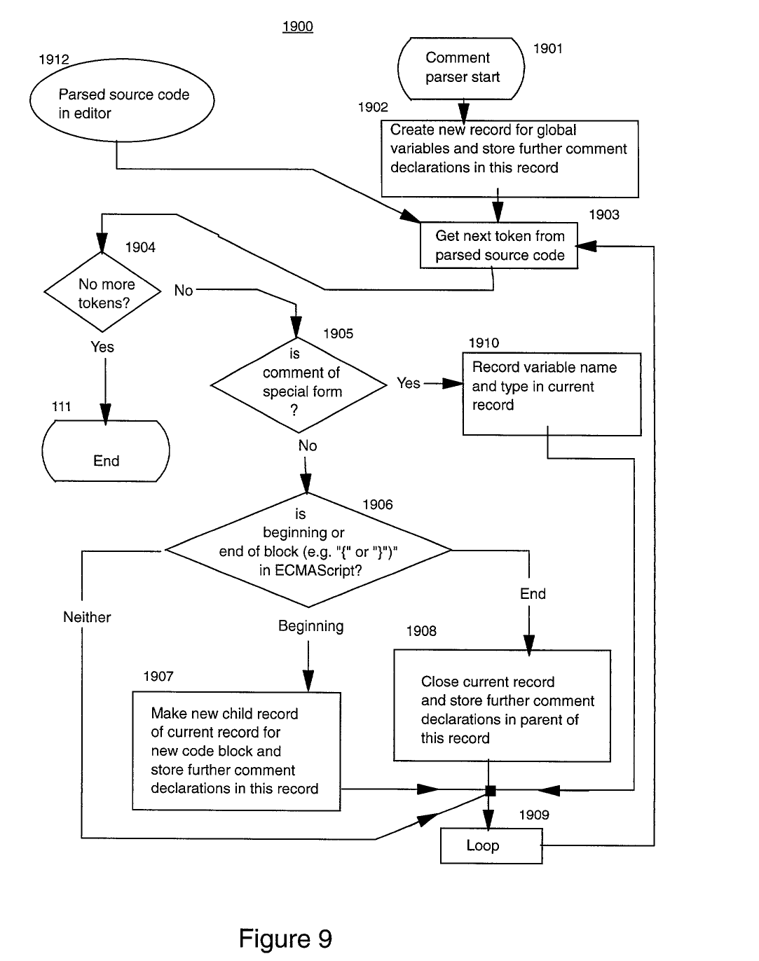

The autoinsertion function is portrayed in the flow diagram in FIG. 9. The comment parser is started 1901. A record is created for the parser to use to understand how to parse the code 1902. The record contains parameters and conventions such as global variables and comment declarations. Subject source code is parsed by the editor 1912 and resultant tokens are provided to the parser 1903. As tokens are identified, they are analyzed to determine if they are comments of the special form 1905 according to a comment coding convention that is implementation dependent. If the token identifies a special command, the function in the special command is recorded 1910 in the initial record 1902. If the code is divided into blocks, a determination is made whether a new block is being entered or exited 1906. If this is a new block, a child record is created for future special function recording 1910. All subsequent special form tokens record to this child record until an end of block is detected 1906. When an end of block is detected, the child record is closed and subsequent special form tokens record to the initial record 1902. Thus blocks of code are provided with separate special function records 1907, separate from the global record 1902.

The following example code listing “DHTMLSourceParser.cpp” shows an example implementation of the expression parser of the present invention.

[image]

[image]

[image]

[image]

[image]

[image]

[image]

[image]

[image]

[image]

[image]

[image]

[image]

[image]

[image]

[image]

[image]

Type Assistant:

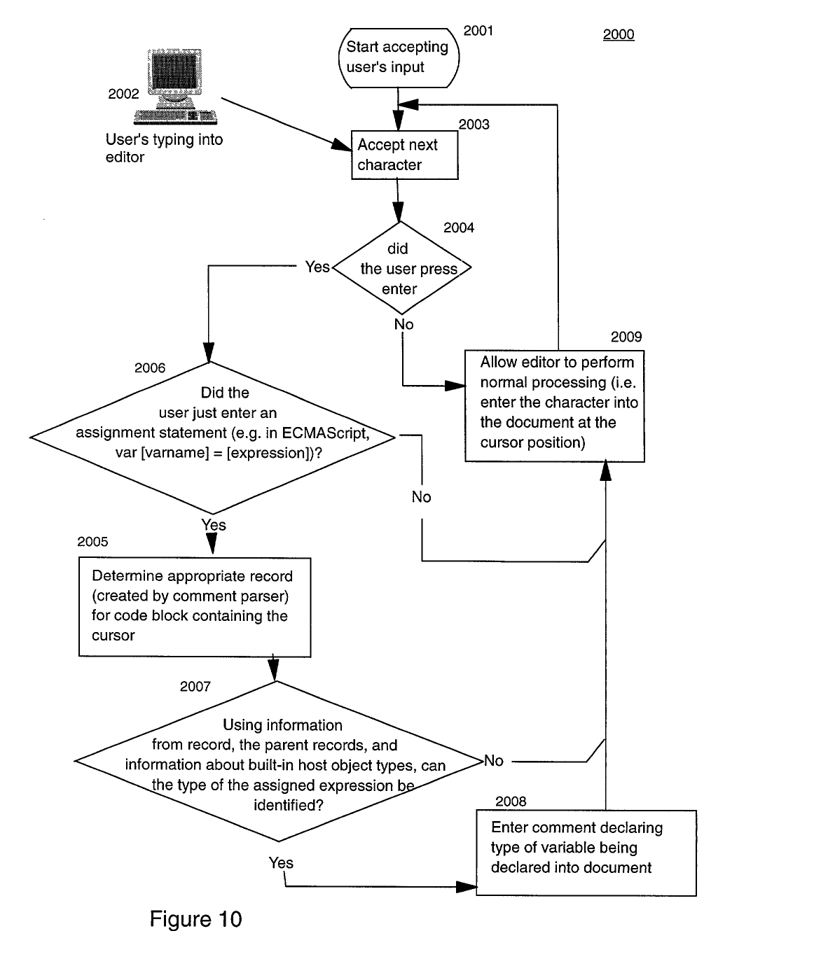

The type assistant function is portrayed in FIG. 10 in a flow diagram. User input typically from a keypad on a personal computer 2002 is supplied to the autoinsertion compiler, a character at a time 2003. At an predetermined event (such as the user hitting the “Enter” key) 2004 the autoinsertion compiler will determine the appropriate record for information about the code block containing the present location of the cursor 2005. If the token preceding the Enter operation contained an assignment statement 2006, then information in the records of the program listing attributes, predefined information such as built-in host object types and other parameters obvious to one skilled in the art, are used to determine if the type of the assigned expression can be identified 2007. If it can be identified, it is entered into the code listing 2008 as a special command according to the present invention.

The following example code listing “TypeInformation.cpp” shows an example implementation of autoinsertion of type information using the present invention.

[image]

[image]

[image]

[image]

[image]

[image]

[image]

[image]

[image]

[image]

[image]

[image]

[image]

[image]

Although preferred embodiments have been depicted and described in detail herein, it will be apparent to those skilled in the relevant art that various modifications, additions, substitutions and the like can be made without departing from the spirit of the invention, and these are therefore considered to be within the scope of the invention as defined in the following claims:

We claim:

1. A method for using special comment language to augment functionality of a program language architecture, the method comprising the steps of:
reading from a storage media, a program listing for performing a basic function in a first executer;
detecting in said program listing, a special comment identifier by analyzing a standard comment statement in said program listing;
interpreting contents of said standard comment statement as a special comment language statement when said special comment identifier is detected in said standard comment statement; and,
performing said basic function and an optional function according to said special comment language statement in a second executer.

2. The method according to claim 1 wherein said special comment identifier comprises a predetermined field left justified in a standard comment format.

3. The method according to claim 1 wherein said special comment identifier comprises a predetermined field right justified in a standard comment format.

4. The method according to claim 1 wherein said special comment identifier comprises a physical location in said program listing.

5. The method according to claim 1 wherein said special comment language statement is context sensitive.

6. The method according to claim 1 wherein said function comprises definition of a variable.

7. The method according to claim 1 wherein said function is simulation environment criteria.

8. The method according to claim 1 wherein said function is specification of type.

9. A method for assisting a user in editing a program wherein said programming environment supports special comment language to augment functionality of a program language architecture, the method comprising the steps of:
analyzing in a program listing, a programming statement entered by said user to determine if an optional special comment language function exists for said programming statement;
determining if said optional special comment language function should be added to said program listing; and,
adding said optional special comment to said program listing.

10. The method according to claim 9 wherein said determining step comprises the further step of displaying a representation of said optional special comment language function to allow said user to sellect a special comment indicating said special language function to be added said program listing.

11. The method according to claim 10 wherein said displaying step comprises a separate window concurently displayed with a previous window.

12. The method according to claim 10 comprising the further step of selectively displaying a help assistant message for said representation of said optional special comment language function.

13. The method according to claim 10 wherein said representation of said optional special comment language function comprises a graphical image.

14. The method according to claim 9 further comprising the step of highlighting a portion of said program listing wherein said portion comprises said programming statement.

15. The method according to claim 9 wherein said analyzing step further comprises analyzing the context of said programming statement in relationship to said program listing.

16. The method according to claim 9 wherein said optional special comment comprises a specification of type.

17. A system for using special comment language to augment functionality of a program language architecture, the system comprising:
means for reading from a storage media, a program listing for performing a basic function in a first executer;
means for detecting in said program listing, a special comment identifier by analyzing a standard comment statement in said program listing;
means for interpreting contents of said standard comment statement as a special comment language statement when said special comment identifier is detected in said standard comment statement; and,
means for performing said basic function and an optional function according to said special comment language statement in a second executer.

18. The system according to claim 17 wherein said special comment identifier comprises a predetermined field left justified in a standard comment format.

19. The system according to claim 17 wherein said special comment identifier comprises a predetermined field right justified in a standard comment format.

20. The system according to claim 17 wherein said special comment identifier comprises a physical location in said program listing.

21. The system according to claim 17 wherein said special comment language statement is context sensitive.

22. The system according to claim 17 wherein said function comprises definition of a variable.

23. The system according to claim 17 wherein said function is simulation environment criteria.

24. The system according to claim 17 wherein said function is specification of type.

25. A system for assisting a user in editing a program wherein said programming environment supports special comment language to augment functionality of a program language architecture, the system comprising:
means for analyzing in a program listing, a programming statement entered by said user to determine if an optional special comment language function exists for said programming statement;
means for determining if said optional special comment language function should be added to said program listing; and,
means for adding said optional special comment to said program listing.

26. The system according to claim 25 wherein said determining means further comprises means for displaying a representation of said optional special comment language function to allow said user to sellect a special comment indicating said special language function to be added said program listing.

27. The system according to claim 26 wherein said displaying means comprises a separate window concurently displayed with a previous window.

28. The system according to claim 26 further comprising means for selectively displaying a help assistant message for said representation of said optional special comment language function.

29. The system according to claim 26 wherein said representation of said optional special comment language function comprises a graphical image.

30. The system according to claim 25 further comprising means for highlighting a portion of said program listing wherein said portion comprises said programming statement.

31. The system according to claim 25 wherein said analyzing means further comprises means for analyzing the context of said programming statement in relationship to said program listing.

32. The system according to claim 25 wherein said optional special comment comprises a specification of type.

33. A computer program product comprising a computer useable medium having compute readable program code means therein in a computing system for using special comment language to augment functionality of a program language architecture, the computer readable program code means in said computer program product comprising:
computer readable program means for reading from a storage media, a program listing for performing a basic function in a first executer;
computer readable program means for detecting in said program listing, a special comment identifier by analyzing a standard comment statement in said program listing;
computer readable program means for interpreting contents of said standard comment statement as a special comment language statement when said special comment identifier is detected in said standard comment statement; and,
computer readable program means for performing said basic function and an optional function according to said special comment language statement in a second executer.

34. The computer program product according to claim 33 wherein said special comment identifier comprises a predetermined field left justified in a standard comment format.

35. The computer program product according to claim 33 wherein said special comment identifier comprises a predetermined field right justified in a standard comment format.

36. The computer program product according to claim 33 wherein said special comment identifier comprises a physical location in said program listing.

37. The computer program product according to claim 33 wherein said special comment language statement is context sensitive.

38. The computer program product according to claim 33 wherein said function comprises definition of a variable.

39. The computer program product according to claim 33 wherein said function is simulation environment criteria.

40. The computer program product according to claim 33 wherein said function is specification of type.

41. A computer program product comprising a computer useable medium having compute readable program code means therein in a computing system for assisting a user in editing a program wherein said programming environment supports special comment language to augment functionality of a program language architecture, the computer readable program code means in said computer program product comprising:
computer readable program code means for analyzing in a program listing, a programming statement entered by said user to determine if an optional special comment language function exists for said programming statement;
computer readable program code means for determining if said optional special comment language function should be added to said program listing; and,
computer readable program code means for adding said optional special comment to said program listing.

42. The computer program product according to claim 41 wherein said determining means further comprises means for displaying a representation of said optional special comment language function to allow said user to sellect a special comment indicating said special language function to be added said program listing.

43. The computer program product according to claim 42 wherein said displaying means comprises a separate window concurently displayed with a previous window.

44. The computer program product according to claim 42 further comprising means for selectively displaying a help assistant message for said representation of said optional special comment language function.

45. The computer program product according to claim 42 wherein said representation of said optional special comment language function comprises a graphical image.

46. The computer program product according to claim 41 further comprising means for highlighting a portion of said program listing wherein said portion comprises said programming statement.

47. The computer program product according to claim 41 wherein said analyzing means further comprises means for analyzing the context of said programming statement in relationship to said program listing.

48. The computer program product according to claim 41 wherein said optional special comment comprises a specification of type.

49. A system for performing a basic function according to statements in a program listing and an optional function according to special comments in the program listing wherein the optional function is not required for performing the basic function, the system comprising:
a storage media;
a computer processor, connected to said storage media;
a program listing stored in said storage media comprising said program statements for performing said basic function and said special comment for performing said optional function; and,
an executer program in said computer processor performing said basic function and said optional function according to said statements and special comment.
